(19) United States
(12) Patent Application Publication
(10) Pub. No.: US 2019/0312540 A1
(43) Pub. Date: Oct. 10, 2019

(54) METHOD AND APPARATUS FOR SOFT STARTING AND STOPPING A MOTOR

(71) Applicant: Shakti Pumps (India) Ltd., Dhar (M.P.) (IN)

(72) Inventors: Chinmay JAIN, Dhar (M. P.) (IN); Manoj MODI, Dhar (M.P.) (IN); Anantha SALIGRAM, Dhar (M.P.) (IN)

(73) Assignee: Shakti Pumps (India) Ltd.

(21) Appl. No.: 16/048,232

(22) Filed: Jul. 28, 2018

(30) Foreign Application Priority Data
Apr. 7, 2018 (IN) 201821013344

(51) Int. Cl. H02P 27/04

(52) U.S. Cl. CPC H02P 27/047

(57) ABSTRACT

The device coupled between a grid and a motor can dynamically soft start and soft stop a motor without the motor experiencing any power surges or jerks.

### CROSS-REFERENCE TO RELATED APPLICATIONS

See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

This disclosure relates to a motor, and more specifically for digitally controlling a start operation and stop operation of a motor in a smooth manner.

### 2. Description of Related Art Including Information Disclosed Under 37 CFR 1.97 and 37 CFR 1.98

U.S. Pat. No. 8,896,334 B2 describes a system for measuring soft starter current includes a current monitoring system including a controller and a current transfer device that includes a first thyristor and a first conductor coupled to the first thyristor and configured to convey a first current flowing through the first thyristor, wherein the first current includes current flowing through the first thyristor when the first thyristor is in an off state. The system also includes a first current sensor configured to sense the first current and a first current measurement circuit coupled to the first current sensor and coupleable to the controller and configured to output a first output value to the controller representative of the first current flowing through the first thyristor. The controller is configured to determine an impending inoperability of the first thyristor based on the first current and alert a user if the first current indicates the impending inoperability.

### BRIEF SUMMARY OF THE INVENTION

Embodiments of the present disclosure are related to a device for controlling switching ON and OFF of a motor, the device coupled between a grid that supplies power and a motor, the device comprising a rectifier coupled to the grid to receive an input voltage from the grid, wherein the rectifier is coupled to an inverter via a capacitor, the capacitor configured to store electrical energy and supply the electrical energy to the inverter, the input voltage from the grid supplied to the motor via inductance that receives the energy from the inverter, the inductance coupled between the inverter and the motor, the inductance configured to store energy in the form of a magnetic field. An input line from the grid prior to the rectifier routed via a thyristor to an output line from the inductance to the motor, wherein the thyristor is a switch connecting the gird to the motor and switching ON and switching OFF the thyristor for supplying energy to the motor controlled by a control circuit coupled to the device. Other embodiments are also disclosed.

### BRIEF DESCRIPTION OF THE SEVERAL VIEWS OF THE DRAWINGS

For a better understanding of the nature and desired objects of the present invention, reference is made to the following detailed description taken in conjunction with the accompanying drawing figures wherein like reference character denote corresponding parts throughout the several views. Objects, features, and advantages of embodiments disclosed herein may be better understood by referring to the following description in conjunction with the accompanying drawings. The drawings are not meant to limit the scope of the claims included herewith. For clarity, not every element may be labeled in every Figure. The drawings are not necessarily to scale, emphasis instead being placed upon illustrating embodiments, principles, and concepts. Thus, features and advantages of the present disclosure will become more apparent from the following detailed description of exemplary embodiments thereof taken in conjunction with the accompanying drawings.

FIG. 1 illustrates a schematic view of an exemplary block diagram of the device in accordance with the present disclosure.

FIG. 2 illustrates a schematic view of an exemplary method for switching ON a motor in accordance with the embodiments of the present disclosure.

FIG. 3 illustrates a schematic view of an exemplary method for switching OFF a motor in accordance with the embodiments of the present disclosure.

### DETAILED DESCRIPTION OF THE INVENTION

Hereinafter, various embodiments of the present disclosure will be described with reference to the accompanying drawings. It should be noted that all of these drawings and description are only presented as exemplary embodiments. It is to note that based on the subsequent description, alternative embodiments may be conceived that may have a structure and method as disclosed herein, and such alternative embodiments may be used without departing from the principle of the disclosure as claimed herein.

It may be appreciated that these exemplary embodiments are provided herein only for enabling those skilled in the art to better understand and then further implement the present disclosure and is not intended to limit the scope of the present disclosure in any manner. Besides, in the drawings, for a purpose of illustration, optional steps, modules, and units are illustrated in dotted-line blocks.

The terms “comprise(s),” “include(s)”, their derivatives and like expressions used herein should be understood to be open, i.e., “comprising/including, but not limited to.” The term “based on” means “at least in part based on.” The term “one embodiment” means “at least one embodiment”; and the term “another embodiment” indicates “at least one further embodiment.” Relevant definitions of other terms will be provided in the description below.

An embodiment of the present invention generally relates to soft starter and more particularly it relates to a contactor less soft starter for induction and magnet motors. In a further embodiment, Soft starters may be used to reduce the initial current of the motor thereby reducing the starting jerk associated with the motor. In a further embodiment, it reduces any electric current surge on starting, and thus improves overall life of the motors and any associated mechanical system.

One embodiment discloses a device for controlling switching ON and OFF of a motor, the device coupled between a grid and a motor, the grid supplying power. In a further embodiment, the device may include a rectifier coupled to the grid to receive an input voltage from the grid. In a further embodiment, the rectifier is coupled to an inverter via a capacitor, wherein the capacitor is configured to store electrical energy and supply the electrical energy to the inverter. In a further embodiment, input voltage from the grid is supplied to the motor through the inverter. In a further embodiment, an inductance is coupled between the inverter and the motor, wherein the inductance configured to store energy in the form of a magnetic field.

In a further embodiment, an input line from the grid prior to the rectifier is routed via a thyristor to an output line from the inductance to the motor. In a further embodiment, the thyristor is a switch connecting the gird to the motor. In a further embodiment, switching ON the thyristor to supply power to the motor and switching OFF the thyristor to shut down the motor is controlled by a control circuit coupled to the device.

In a further embodiment, the rectifier may be at least one of a single phase rectifier or a three phase rectifier. In a further embodiment, the rectifier may include diodes or other electronic components. In a further embodiment, the rectifier is described within the scope of the present disclosure is an electrical device which converts an alternating current into a direct current by allowing a current to flow through it in one direction only.

In a further embodiment the inverter is at least one of a single phase inverter or a three phase inverter. In a further embodiment, the inverter may include switches or other electronic components. In a further embodiment, an inverter is an electronic device or circuitry that changes direct current (DC) to alternating current (AC).

In a further embodiment, a Voltage to frequency (V/f) ratio is controlled by the inverter between the motor and the inverter, such that the voltage and frequency of inverter reaches a steady state within a pre-defined time. In a further embodiment, the pre-defined time may be set automatically or manually by a user. In a further embodiment, the control circuit is configured to identify that a steady state is reached and is further configured to switch ON the thyristor and switched OFF the inverter. In a further embodiment, after the control circuit attains the steady state, power is supplied to the motor from the grid via the thyristors thereby attaining a dynamic soft start and the power is supplied to the motor without any spikes.

In a further embodiment, an internal reference is generated for the frequency and phase, and subsequently the frequency and phase of the grid is synchronized. In a further embodiment, during synchronization the inverter is in an OFF state, and the blanking time is provided by control circuit, wherein the blanking time is of the order of a few milliseconds. In a further embodiment, after this the Inverter is turned ON and using the constant voltage to the frequency ratio, the voltage across the motor may be gradually decreased, thereby attaining a soft stop without any jerks. A further embodiment may include a system that includes a device with a control circuit connected between a grid and a motor for dynamically soft switching ON and switching OFF the motor.

In one embodiment, the disclosure relates to the development of contactor less soft starter with smooth transition. In a further embodiment, the Soft starters may be used to reduce the initial current of the motor resulting in reduction of starting jerk of the motor. In a further embodiment, the soft starter (also referred to as device) may reduce any electric current surge, and thus prevents the motor from any mechanical and electrical shock. In a further embodiment, the soft starter may to ramp up the voltage from low to high for smooth starting, where the conventional soft starter based on the thyristor incorporated with separate bypass contactor, thereby enabling the grid run of the motor. In a further embodiment, a conventional thyristor based soft starter's works by firing angle control on input AC waveform and therefore it gives chopped parts of fundamental frequency AC waveform in the output, leading to poor quality AC on the output. In a further embodiment, a conventional thyristor based soft starter works well with the induction motor.

In a further embodiment, the motors may have a magnet on rotating body jerk which is observed due to magnet braking torques. In a further embodiment, these jerks may not be acceptable due to mechanical constraints in various applications such as submersible motor pump sets etc. In a further embodiment, to overcome shortcoming with existing motors, the present disclosure has been introduced, which results in better quality output voltage waveform which intern helps jerk free start & stop unlike conventional system. In a further embodiment, the present disclosure works with single-phase and three phase configuration with induction and magnet based motors.

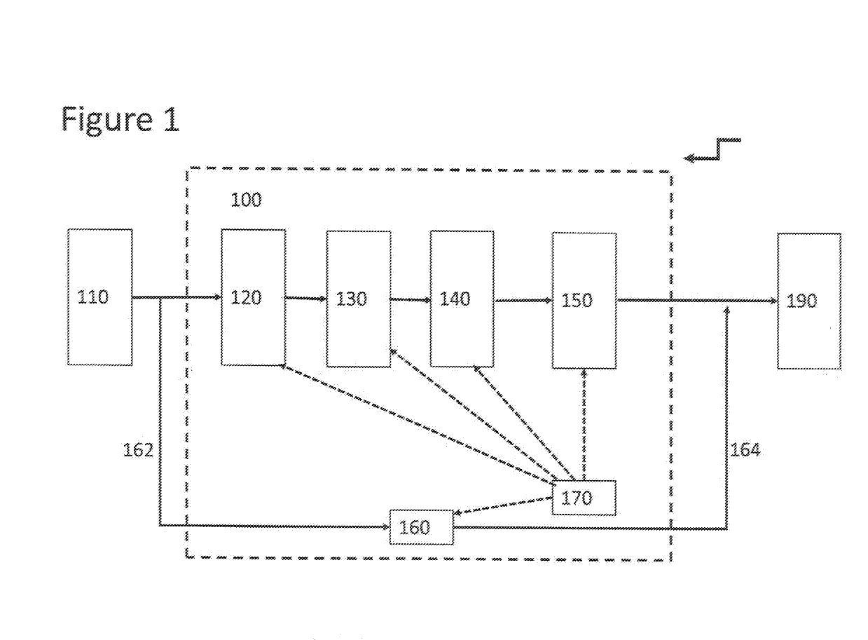

Reference is now made to FIG. 1, which illustrates an exemplary embodiment of a block diagram of a device in accordance with the embodiments of the present disclosure. FIG. 1 illustrates grid 110, wherein the grid supplies power and the power supplied may be used to drive several electrical equipment's including a motor. Device 100 is used for controlling power supplied to motor 190, wherein device 100 is configured for switching ON and switching OFF the motor. Under normal circumstances, there are spikes, surges and jerks in the power supply which may damage the motor. Device 100 is coupled to grid 110 on one end and to motor 190 on the other end.

The device 100 has rectifier 120 coupled to grid 110, and the rectifier received input power from the grid. Rectifier 120 is an electrical device which converts an alternating current into a direct current by allowing a current to flow through it in one direction only. The process is known as rectification, because it “straightens” the direction of current. Physically, rectifiers take a number of forms, including vacuum tube diodes, mercury-arc valves, stacks of copper and selenium oxide plates, semiconductor diodes, silicon-controlled rectifiers and other silicon-based semiconductor switches. Rectifier 120 is coupled to inverter 140 via a capacitor 130, wherein the capacitor is configured to store electrical energy and supply the electrical energy to inverter 140. The input voltage from grid 110 supplied to the motor 190 through the inverter 140, wherein an inductance 150 is coupled between the inverter 140 and the motor 190. The inductance is configured to store energy in the form of a magnetic field.

Input line 162 from grid 110 prior to rectifier 120 routed via a thyristor 160 to an output line 164 from inductance 150 to the motor 190. Tyristor 160 is a switch connecting gird 110 to the motor 190, wherein switching ON and switching OFF thyristor 160 controlled by a control circuit 170. Control circuit 170 is coupled to rectifier 120, capacitor 130, inverter 140 and inductance 150 and is configured to control the elements and the power supply within the device.

A breaker circuit can be provided between the capacitor and the inverter, which is not shown in the block diagram in order to simplify the circuit.

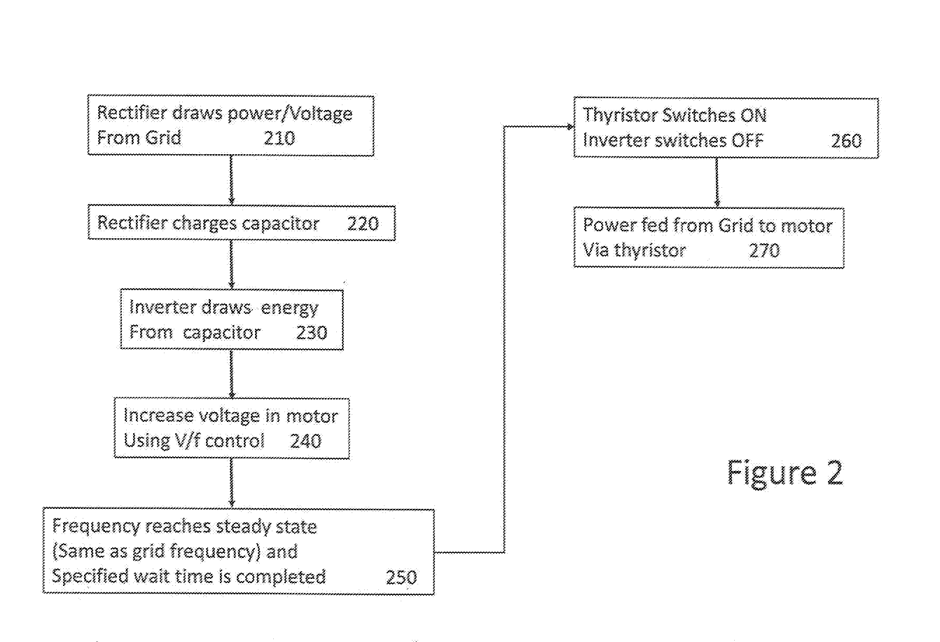

Reference is now made to FIG. 2, which illustrates an exemplary method of switching ON the motor in accordance with the embodiments of the present disclosure.

As illustrated in Step 210 the rectifier draws power from the grid. Power and voltage are used interchangeably in this disclosure. The rectifier can be a single phase rectifier or a three phase rectifier. In Step 220, the voltage from the rectifier is supplied to the Capacitor, preferably a shunt capacitor, to charge the capacitor. The inverter in the circuit draws energy from the capacitor in Step 230. In step 240, voltage in the motor is increased using V/f control, which is a standard method, but it should be obvious to one skilled in the art that other method may be used as well, wherein the V/f ratio cannot be controlled in normal starters/device. In step 250, the voltage & frequency reaches a steady state, which means that the voltage, frequency & phase is now the same as the grid and also a specified wait time is completed, which may be defined by the user or set automatically. Once a steady state is reached, the control circuit switches ON the thyristors and switches OFF the inverter. In step 270, power is directly fed from the grid to the motor via the thyristors, which is a steady state power, thereby avoiding any spikes, power surges and jerks. This is referred to a soft start of the motor.

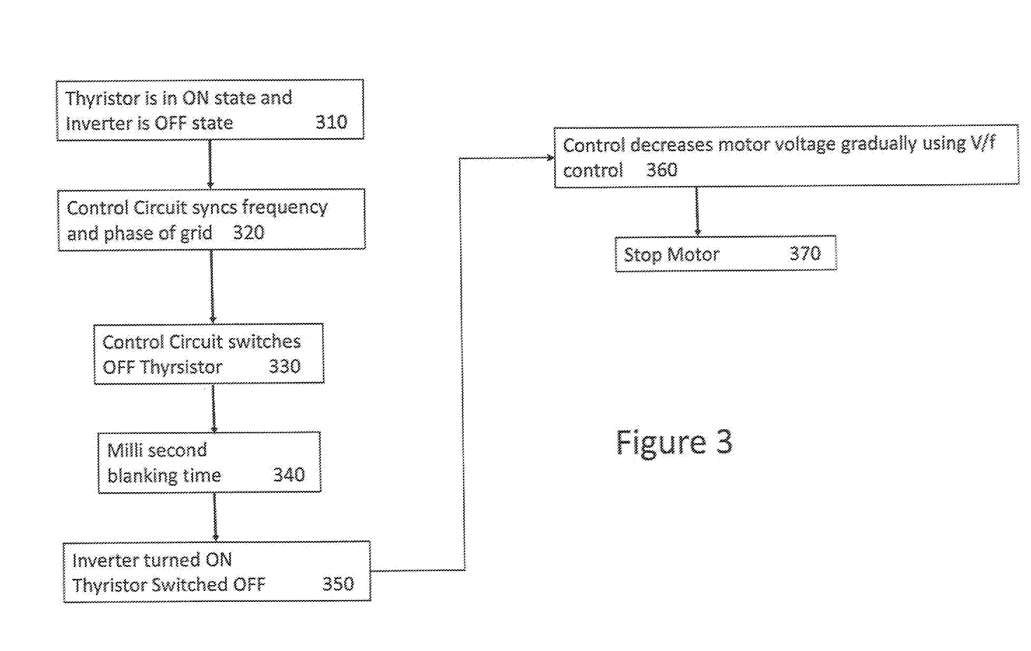

Reference is now made to FIG. 3, which is an exemplary embodiment of switching OFF a motor in accordance with embodiments of the present disclosure. The motor is in ON state and needs to be switched OFF, but should be done in a smooth manner. In step 310, the thyristors is in an ON state and the inverter is in OFF state. In step 320, the frequency, voltage & phase of the inverter is synchronized with the power of the grid and a short time delay is allowed. In step 330, the control circuit switches OFF the Thyristor. In step 340, a few milliseconds time delay is allowed. Preferably about 10 milliseconds is found to be ideal time. In step 350, the inverter is turned ON and the thyristor is switched OFF. In step 360, V/f is now controlled such that it decreases the voltage gradually across the motor. In step 370, the motor is switched off in a smooth manner, which is referred to as soft.

The accompanying figures and description depicted and described embodiments of the present disclosure, and features and components thereof. Those skilled in the art will appreciate that any particular program nomenclature used in this description was merely for convenience, and thus the present disclosure should not be limited to use solely in any specific application identified and/or implied by such nomenclature. Thus, for example, the routines executed to implement the embodiments of the invention, whether implemented as part of an operating system or a specific application, component, program, module, object, or sequence of instructions could have been referred to as a “program”, “application”, “server”, or other meaningful nomenclature. Indeed, other alternative hardware and/or software environments may be used without departing from the scope of the invention. Therefore, it is desired that the embodiments described herein be considered in all respects as illustrative, not restrictive, and that reference be made to the appended claims for determining the scope of the invention.

Although embodiments of the invention have been described using specific terms, such description is for illustrative purposes only, and it is to be understood that changes and variations may be made without departing from the spirit or scope of the following claims.

1. A device for controlling switching ON and OFF of a motor, the device coupled between a grid and a motor, the device comprising:
a rectifier coupled to the grid to receive an input voltage from the grid, wherein the rectifier is further coupled to an inverter via a capacitor, wherein the capacitor is configured to store electrical energy and supply the electrical energy to the inverter via an inductance to the motor, the inductance configured to store energy in the form of a magnetic field; and
an input line from the grid prior to the rectifier routed via a thyristor to an output line from the inductance to the motor, wherein the thyristor is configured to be a switch connecting the gird to the motor control circuit configured to switch ON the thyristor and switch OFF the inverter to supply power to the motor, and control circuit configured to switching OFF the thyristor 160 and switch ON the inverter to power OFF the motor.

2. The device as claimed in claim 1, wherein the rectifier is not limited to single phase rectifier or a three phase rectifier or a power factor correction based AC-DC power conversion stage, wherein the rectifier comprises at one of a group consisting of diodes and controlled switches.

3. The device as claimed in claim 1, wherein the inverter is comprised of at least one of a single phase inverter or a three phase inverter, and the inverter comprises switches.

4. The device as claimed in claim 1, wherein a Voltage/frequency ratio is controlled by the capacitor such that the frequency reaches a steady state within a pre-defined time.

5. The device as claimed in claim 4, wherein the after attaining a steady state the control circuit is configured to switches ON the thyristor and switched OFF the inverter.

6. The device as claimed in claim 4, wherein after attaining steady state power is supplied to the motor from the grid via the thyristors thereby attaining a soft start without any spikes.

7. The device as claimed in claim 4, wherein an internal reference is generated for the frequency, and synchronizing the frequency and phase of the grid.

8. The device as claimed in claim 6, wherein during synchronization the inverter is in an OFF state, the Thyristor is switched OFF in a blanking time is provided by control, wherein the blanking time is of the order of a few milliseconds.

9. The device as claimed in claim 7, wherein the Inverter is turned ON and using the voltage to the frequency ratio, the voltage across the motor is gradually decreased, thereby attaining a soft stop without any spikes.

10. A system comprising the device as claimed in claim 1.
